(19) United States
(12) Patent Application Publication
(10) Pub. No.: US 2006/0157128 A1
(43) Pub. Date: Jul. 20, 2006

(54) Swing spout with positional locking device

(76) Inventors: Steven Anthony Frackowiak, Mentor, OH (US); Yaakov Korb, Elyria, OH (US); Alfred Schiazza, Avon Lake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/036,718

(22) Filed: Jan. 14, 2005

(51) Int. Cl. F16K 21/00

(52) U.S. Cl. 137/801

(57) ABSTRACT

A locking device is provided with a faucet spout. The locking device is operable to lock the spout into a fixed position. The spout is rotated by pushing the spout in a desired direction. As the spout is rotated, the locking device locks the spout into a fixed position when the spout reaches a predetermined position.

### FIELD OF AND BACKGROUND OF THE INVENTION

The invention relates to faucet spouts. More specifically, the invention is related, but not limited, to a swing spout having a locking feature as the spout rotates into a predetermined position.

Some faucets have a spout which is capable of rotating to allow water to be distributed to different parts of a sink or tub. This feature allows a user to rotate the spout in a circumferential direction to a desired location. Once the spout has been moved to the desired location, the spout generally remains in that position but is not locked into that position. At any time, a user may reposition the spout by applying a small circumferentially-directed force to the spout and removing the force when the spout has rotated to the desired position. Again, the spout will generally remain in the desired position, in an unlocked state, until another small circumferentially-directed force is applied to the spout. However, since the spout is not locked into position, it may be unintentionally moved.

### SUMMARY OF THE INVENTION

In one embodiment of the present invention, a locking device is provided with a faucet spout. The locking device is operable to lock the spout into a fixed position. The spout is rotated by pushing the spout in a desired direction. As the spout is rotated, the locking device locks the spout into a fixed position when the spout reaches a predetermined position.

Numerous other advantages and features of the present invention will become readily apparent from the following detailed description of the invention and the embodiments thereof, from the claims and from the accompanying drawings.

### BRIEF DESCRIPTION OF THE DRAWINGS

The invention as well as embodiments and advantages thereof are described below in greater detail, by way of example, with reference to the drawings in which:

FIG. 1 is a perspective view of a swing spout in accordance with an embodiment of the present invention;

FIG. 2 is an exploded perspective view of the swing spout of FIG. 1, without a collar;

FIG. 3 is a perspective view of the swing spout of FIG. 1, without a collar in an unlocked position;

FIG. 4 is a perspective view of the swing spout of FIG. 1, without a collar in a locked position; and

FIG. 5 is a cross-sectional view of the swing spout of FIG. 1 in a locked position.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

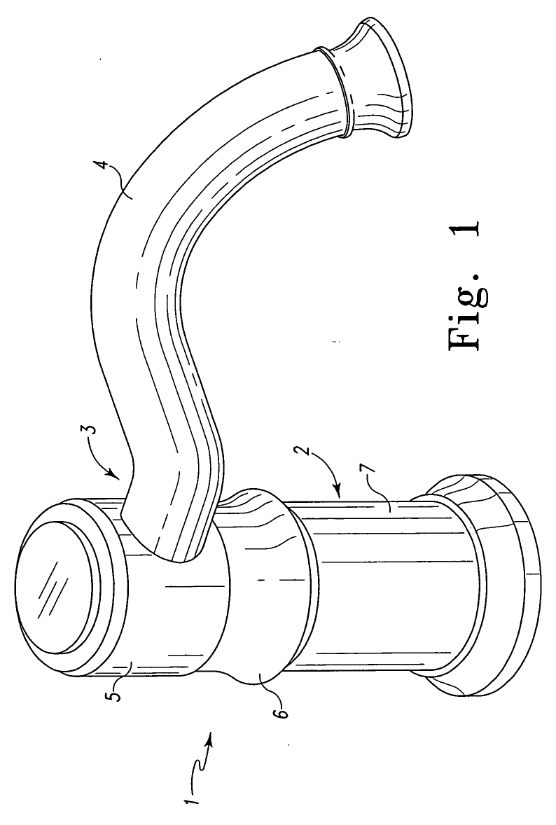

FIG. 1 shows a swing spout faucet 1 in accordance with an embodiment of the present invention. In one embodiment, the swing spout 1 comprises a base 2 and the spout apparatus 3. The spout apparatus 3 is disposed over the base 2 and is operable to rotate about a central longitudinal axis of the base 2. Furthermore, the base 2 and spout apparatus 3 have inter-connecting waterways which allow water to flow from a water supply pipe (not shown) connected to the bottom of the base 2 into the spout tube 4.

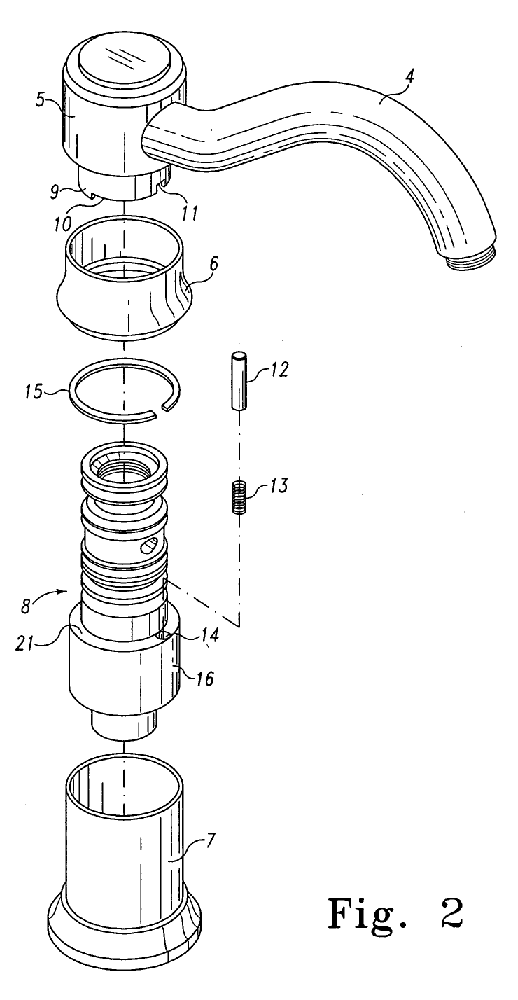

Referring now to FIG. 2, an exploded view of the swing spout 1 is shown. In order to make the present invention easier to see and understand, the sealing and bearing members (such as o-rings) are not illustrated in FIG. 2.

The spout apparatus 3 comprises a spout tube 4 and a spout hub 5. The spout tube 4 extends from the spout hub 5. Both the spout tube 4 and spout hub 5 have inter-connecting waterways which allow water to flow therethrough. The size, shape and material used to form the spout tube 4 and spout hub 5 may vary. In one embodiment, the base 2 comprises an escutcheon 7 and a nipple 8. Like the spout tube 4 and spout hub 5, the escutcheon 7 and the nipple 8 may vary in size, shape and material.

A lower portion 16 of the nipple 8 sits within the escutcheon 7. The nipple 8 provides a central waterway to allow water to flow from a water supply pipe to the spout tube 4. Although the waterway in the nipple 8 is centralized, the nipple 8 may have a non-centralized waterway and may even have a plurality of inter-connected waterways to provide passage of the incoming water to the spout tube 4.

A collar 6 is disposed around an upper portion 17 of the nipple 8, and between the spout hub 5 and the escutcheon 7. The collar 6 is used to disengage the stop 12 when the stop is engaged in the aperture 11.

The spout hub 5 is disposed over the upper portion 17 of the nipple 8. The area between the outer surface of the nipple 8 and the inner surface of the spout hub 5 are sealed using sealing devices (not shown) such as o-rings. This prevents water flowing through the nipple 8 and spout hub 5 from leaking.

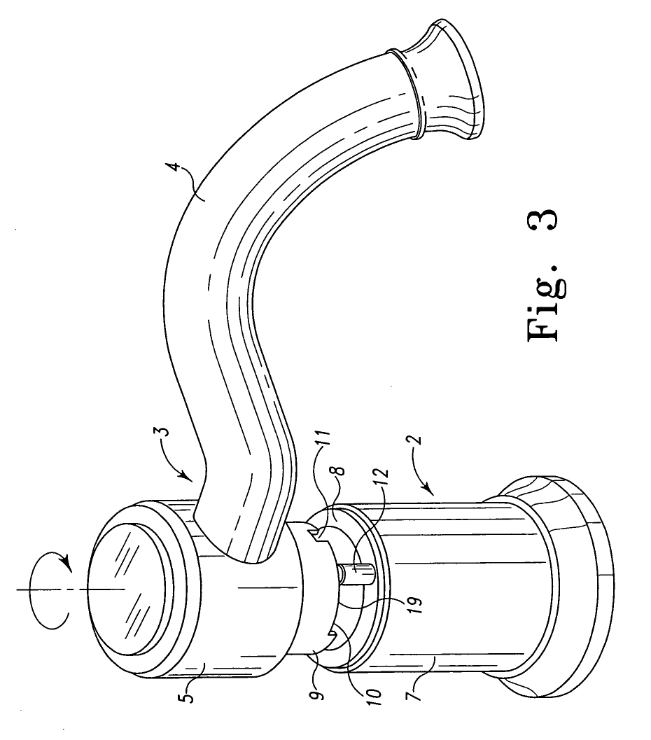

A lower portion of the spout hub 5 comprises a rotational limiting portion 9, a rotating channel 10 and an aperture 11. These components work in conjunction with a stop 12 and a spring 13 that are disposed within a cavity 14 of the lower portion 16 of the nipple 8 to provide rotational limits and a locking feature. The rotational limitation and locking feature will be explained in more detail with respect to FIG. 3-5 below.

Also shown in an optional lock out collar 15. The lock out collar 15, when used, is disposed between the lower surface of the lower portion of the spout hub 5 and the ledge on the nipple 8 having the cavity 14. The lock out collar 15 may be inserted to prevent the stop 12 from engaging the aperture 11 by raising the spout hub 5 away from the stop 12.

Referring to FIG. 3, the swing spout is shown in an unlocked position. In FIG. 3, the collar 6 has been removed for easier viewing. As discussed above, the spring 13 (or other urging member) is disposed in the cavity 14 of the nipple 8. After the spring 13 is placed in the cavity 14, the stop 12 is then placed in the cavity 14, on top of the spring 13. The spring 13 provides an upward force on the stop 12 which causes a top 18 of the stop 12 to abut against an upper surface 19 of the rotating channel 10. In another embodiment, the spring 13 or other urging member is not used and the stop 12 sits alone in the cavity 14. In such a case, gravitational forces will cause the upper surface 19 of the rotating channel 10 to abut the top 18 of the stop 12 while the stop 12 is in the rotating channel 10. In order for gravitational forces to cause this effect, the use of o-rings may have to me modified or limited.

In the unlocked position, the spout apparatus 3 is free to rotate about the stationary base 2 while the stop 12 is disposed in the rotating channel 10. As shown in FIG. 3, as the spout apparatus 3 is rotated in a counter-clockwise direction, the stop 12 is consistently urged against the upper surface 19 of the rotating channel 10 as a result of the upward force of the spring 13. The spout apparatus 3 is free to rotate in a counter-clockwise direction (as shown in FIG. 3) in the unlocked position until the stop 12 contacts the rotational limiting portion 9 of the spout hub 5. At this point, the spout apparatus 3 is prevented from further rotating about the base 2.

As shown in FIG. 3, the rotational limiting portion 9 is a lower extending portion of the spout hub 5. In other embodiments, the rotational limiting portion 9 could be a separate piece which limits the rotational angle that the spout apparatus 3 is allowed to rotate about the base 2. Additionally, the rotational limiting portion 9 may be designed and adjusted to allow more or less rotational angle. Furthermore, although not specifically shown in FIG. 3, the rotational limiting portion 9 extends circumferentially around the spout hub 5 to a desired position such that if the spout is in the unlocked position (and the stop 12 is on the other side of the aperture 11) and rotated clockwise, the stop 12 would come into contact with the rotational limiting portion 9 and prevent the spout apparatus 3 from rotating about the base 2 in the clockwise direction. The rotational limiting portion 9 does not have to necessarily extend circumferentially around the spout hub 5, but may be two small discrete downward-extending projections located on both ends of the rotating channel 10.

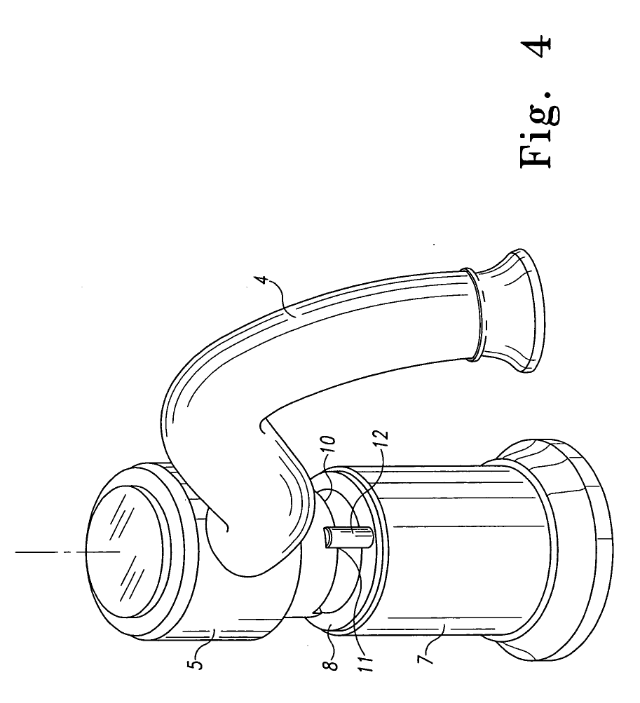

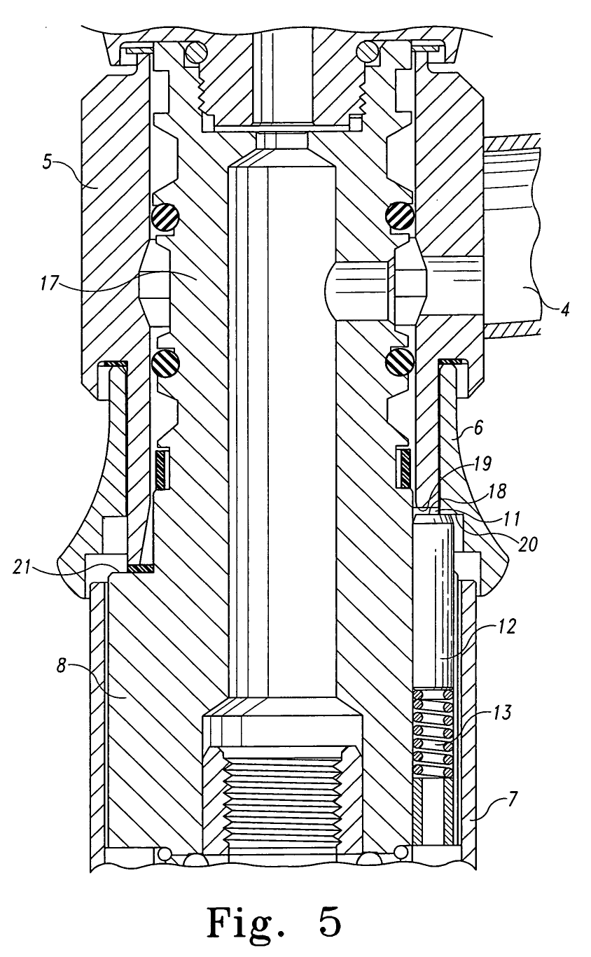

When the spout apparatus 3 shown in FIG. 3 (i.e. stop 12 positioned to the left of the aperture 11) is rotated in the clockwise direction, it enters a locked position when the stop 12 is positioned directly below the aperture 11. At this point, the stop 12 is urged upward by the spring 13 (shown in FIGS. 2 and 5) such that the stop 12 engages the aperture 11. The spout apparatus 3 is then in a locked position as shown in FIGS. 4 and 5. In other words, the spout apparatus 3 is no long free to rotate about the base 2 and is essentially “locked” into a fixed rotational position relative to the base 2. As stated above, this locked position is shown in FIGS. 4 and 5.

Referring now to FIG. 4, the spout apparatus is shown in the locked position. As shown, the stop 12 is engaged and disposed within the aperture 11. The aperture 11 may be shaped to match the shape of the stop 12. Furthermore, the size of the aperture 11 may be large enough such that the stop 12 may slide in and out of the aperture 11 but small enough to prevent the spout apparatus 3 from being significantly rotated about the base 2.

As shown in FIG. 4, when in the locked position, the stop 12 engages the aperture 11. The sides of the stop 12 prevent the rotation of the spout apparatus 3 about the base 2 by contacting the sides of the aperture 11 when there is an attempt to rotate the spout apparatus 3 about the base 2. When a spring 13 or other urging member is disposed in the cavity 14 below the stop 12, the stop 12 automatically engages the aperture 11 when the spout apparatus 3 is rotated into the locked position and thus the stop 12 automatically locks the spout apparatus 3 into the locked position. If the spring 13 or other urging member is used, the force of gravity will cause the spout apparatus 3 to move into the locked position when the aperture 11 aligns with the stop 12.

In FIG. 4, the aperture 11 is centered below the spout tube 4. However, the location of the aperture 11 on the spout hub 5 may vary. For example, the aperture 11 may be to the left or right of the spout tube 4. Similarly, there may be more than one aperture 11. When more than one aperture 11 is used, there becomes more than one locked position.

While the embodiment in FIG. 4 shows the stop 12 being urged upwardly to engage the aperture 11, the stop 12 may also be urged in other directions. For example, the stop 12 may be urged radially outward using an urging member. Thus, the stop 12 may engage the aperture 11 from other directions than that shown in FIG. 4. In other words, the direction of the urging force of the stop 12 may vary.

Similarly, at stated previously, other types of urging members may be used in place of or in addition to the spring 13. For example, a magnet or even water pressure may be used to provide the necessary urging force to the stop 12.

Depending on the desired design, the aperture 11, rotating channel 10 and rotational limiting portion 9 may be disposed or located on parts other than the spout hub 5. For example, the aperture 11 may be disposed on the nipple 8 instead of the spout hub 5. Such designs may require additional parts in order to operate properly, however, such embodiments are within the scope of the present invention.

When the spout apparatus 3 is in the locked position, the collar 6 (as shown in FIGS. 1 and 5) is used to disengage the stop 12 from the aperture 11 so that the spout apparatus 3 may then be rotated about the base 2 and rotated into the unlocked position. This concept is explained below with reference to FIG. 5.

Referring now to FIG. 5, a cross-sectional view of the swing spout faucet 1 is shown. As shown in FIG. 5, the spout apparatus 3 is in the locked position. Accordingly, the stop 12 is engaged and disposed in the aperture 11. When a user wishes to rotate the spout apparatus 3 when in the locked position (i.e. unlock the spout apparatus), the stop 12 must first be disengaged and removed from the aperture 11. To accomplish this, the collar 6 is used to transfer a downward (or opposite) force on the stop 12. The direction of the force transferred by the collar 6 may vary and will depend on the direction of engagement of the stop 12 within the aperture 11 and the urging force of the spring 13. In FIG. 5, a downward force is necessary to move the stop 12 downward and out of engagement with the aperture 11.

The force is applied to the outer surface of the collar 6 by a user. The collar 6 transfers that force to the stop 12. The collar 6 has an interior surface which abuts the top of the stop 12 when the spout apparatus 3 is in the locked position as shown in FIG. 5. When the user applies a downward force to the collar 6, the collar 6 transfers that force to the stop 12. If the transferred force is greater than the urging force applied by the spring 13, the stop 12 will move downward and out of engagement with the aperture 11.

Once the stop 12 is moved out of engagement with the aperture 11, the spout apparatus 3 is free to rotate about the base 2. The downward force must remain, holding the stop 12 out of engagement with the aperture 11, until the spout apparatus 3 is rotated far enough that the stop 12 is not properly aligned with the aperture 11 (i.e. the unlocked position). At this point, the downward force may be removed and the stop 12 will be urged by the spring 13 against the upper surface 19 of the rotating channel 10 (bottom surface of the spout hub 5).

The shape, design and location of the collar 6 may vary depending on the specific design of the swing spout 1. For example, if the collar 6 is not used, a user may manually have to disengage the stop 12 from the aperture 11 by pushing the stop 12 down or by lifting up on the spout apparatus 3.

Finally, if a user does not wish to have the spout apparatus 3 rotate, but instead wishes for the spout apparatus to always remain in the locked position, a lock out collar 15 is disposed between the interior surface 20 of the collar 6 and a ledge 21 of the nipple 8. The lock out collar 15 prevents the collar 6 from moving downward since the interior surface 20 of the collar 6 abuts the lock out collar 15. As a result, if a user applies a downward force on the collar 6, the collar 6 would not be able to move downward because the lock out collar 15 would prevent its downward movement. Therefore, the downward force applied by the user cannot be transferred to the stop 12 sufficiently enough to cause the stop 12 to move downward and become disengaged from the aperture 11.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A swing spout comprising:
a spout apparatus; and
a locking mechanism;
wherein said locking mechanism is operable to lock said spout apparatus in a fixed position when said spout apparatus is rotated to a predetermined position.

2. The swing spout of claim 1, wherein said locking mechanism is operable to be unlocked which allows said spout apparatus to be freely rotated.

3. The swing spout of claim 2, wherein said swing spout further comprises a collar disposed axially around an outer surface of said spout apparatus, and wherein said collar is operable to unlock said locking mechanism.

4. A faucet comprising:
a base;
a spout apparatus rotatable about said base; and
an automatic locking device operable to lock said spout apparatus in a fixed position relative to said base when said spout apparatus is rotated to a predetermined position.

5. The faucet of claim 4, wherein said automatic locking device is disposed partially within said base; and wherein said automatic locking device is urged against said spout apparatus.

6. The faucet of claim 4, wherein said base comprises a nipple and said spout apparatus comprises a spout hub; wherein said automatic locking device is disposed partially within said nipple; and wherein said automatic locking device is disposed between said nipple and said spout hub.

7. The faucet of claim 4, wherein said spout apparatus includes a locking aperture operable to receive said automatic locking device.

8. The faucet of claim 7, wherein said automatic locking device engages said locking aperture when said spout apparatus is rotated to said predetermined position.

9. The faucet of claim 7, wherein said spout apparatus further includes a rotating channel operable to receive said automatic locking device when said spout apparatus is not in said predetermined position.

10. The faucet of claim 9, wherein said spout apparatus further includes a rotational limiting portion which limits a rotational angle range of said spout apparatus.

11. The faucet of claim 4, wherein said automatic locking device is operable to be unlocked which allows said spout apparatus to be freely rotated about said base.

12. The faucet of claim 11, wherein said faucet further comprises a collar operable to unlock said automatic locking device which allows said spout apparatus to be freely rotated about said base.

13. The faucet of claim 4, and wherein said automatic locking device comprises an urging member and a stop, wherein said urging member urges said stop against said spout apparatus.

14. The faucet of claim 13, wherein said base comprises a collar and said collar is operable to transmit to said stop a force opposite to a force provided by said urging member to thereby unlocking said automatic locking device member.

15. The faucet of claim 13, wherein said spout apparatus comprises a locking aperture and wherein said stop is urged into said locking aperture by said urging member when said spout apparatus is rotated to said predetermined position.

16. The faucet of claim 4, wherein said spout apparatus comprises a spout hub and said spout hub includes a locking aperture operable to receive said automatic locking device;
wherein said automatic locking device comprises an urging member and a stop, wherein said urging member urges said stop against said spout hub and wherein said stop is urged into said locking aperture by said urging member when said spout apparatus is rotated to said predetermined position;
wherein said faucet further comprises a collar operable to disengage said stop from said locking aperture which allows said spout apparatus to be freely rotated about said base; and
wherein said collar is operable to transmit to said stop a force opposite to a force provided by said urging member to thereby disengage said stop from said locking aperture.

17. The faucet of claim 4, wherein said spout hub includes a rotational channel operable to receive said automatic locking device when said spout apparatus is not in said predetermined position; and
wherein said spout hub further includes a rotational limiting portion which limits a rotational angle range of said spout apparatus.

18. The faucet of claim 4, further comprising a lock out collar disposed between said base and said spout which prevents said automatic locking device from being disengaged from said spout apparatus.

19. A method for positioning a spout comprising the steps of:
rotating said spout to a predetermined position, and
locking said spout into a fixed rotational position upon reaching said predetermined position using a locking mechanism.

20. The method of claim 19, further comprising the steps of:
unlocking said locking mechanism from said spout; and
rotating said spout.

21. The method of claim 20, wherein said disengaging step comprises the steps of:
applying a force to a collar and transmitting said force to said locking mechanism to unlock said locking mechanism, thereby permitting said spout to rotate from said predetermined position; and
removing said force after said spout has rotated from said predetermined position.

22. The method of claim 21, wherein said locking mechanism includes a locking member and a locking aperture, wherein said locking member engages said locking aperture when said spout is rotated into said predetermined position; and
wherein said locking member is disposed within a rotating channel of said spout when said spout is not in said predetermined position.

23. The method of claim 22, further comprising the steps of:
wherein said force applied to said collar is directionally downward and moves said locking member out of said locking aperture and allows rotational movement of said spout.
